(19) United States
(12) Patent Application Publication
(10) Pub. No.: US 2015/0172653 A1
(43) Pub. Date: Jun. 18, 2015

(54) VIDEO CODING AND DECODING METHOD WITH ADAPTATION OF CODING MODES AND CORRESPONDING ENCODER AND DECODER

(71) Applicant: THOMSON LICENSING, Issy de Moulineaux (FR)

(72) Inventors: Edouard Francois, Bourg des Comptes (FR); Dominique Thoreau, Cesson Sevigne (FR); Jerome Vieron, Paris (FR); Philippe Bordes, Laille (FR)

(21) Appl. No.: 14/412,998

(22) PCT Filed: Jun. 27, 2013
(86) PCT No.: PCT/EP2013/063527

§ 371 Date: Jan. 5, 2015

(30) Foreign Application Priority Data
Jul. 5, 2012 (FR) 1256473

(51) Int. Cl. H04N 19/103; H04N 19/50; H04N 19/176

(52) U.S. Cl. CPC H04N 19/103; H04N 19/176; H04N 19/50

(57) ABSTRACT

A method for coding or decoding pixel blocks is disclosed. The number of usable modes at the coder and at the decoder is limited to a subset of the set of possible coding modes and the content of this subset is regularly adapted to the content of the images of the sequence. Thus, the coder or decoder always only has a reduced number q<n of coding modes available, called available coding modes, to code or decode the current pixel block but this subset of q coding modes is regularly modified according to the pixel blocks already coded or decoded.

### TECHNICAL FIELD

The invention lies in the field of video coding and decoding. It relates more specifically to a method for coding and decoding pixel blocks having a reduced cost in terms of quantity of information to be coded or decoded.

### PRIOR ART

In standard coders, for example H.264/AVC coders, several coding modes are used for spatial or temporal prediction. Each of the coding modes used is referenced by an index which is specific to it. These coding modes are contained in a set of coding modes. This set contains for example n coding modes. When a coding mode is used to determine the prediction block of a current pixel block, the index of the coding mode used to determine the prediction block is coded with the residual block into a bitstream by entropy coding to reduce the quantity of bits to be transmitted. This entropy coding makes it possible notably to reduce the quantity of bits used for coding the coding mode indices, the number of bits of a coding mode index being inversely proportional to its rate of use.

According to the content to be coded, some coding modes are dominant while others are almost unused. Adaptive entropy coding, due to a regular update of the rate of use of the coding modes, takes account of this phenomenon in order to code the mode index efficiently. However, when the number of possible coding modes becomes significant, limits are reached both in terms of efficiency and in terms of encoding complexity. In fact, the coder must continuously code all possible coding modes with all authorized configurations.

### SUMMARY OF THE INVENTION

One purpose of the invention is to propose a coding and decoding method enabling the management of a large number of coding modes ensuring good coding efficiency without increasing the encoding complexity.

According to the invention, it is proposed to limit the number of usable modes at the coder and at the decoder to a subset of the set of possible coding modes, and to adapt regularly the content of this subset to the content of the images of the sequence.

The purpose of the invention is also a method for coding pixel blocks of a video sequence comprising a step of coding of each of the pixel blocks according to a coding mode selected, according to a first predetermined criterion, from a subset of q coding modes of a set of n possible coding modes, where q<n,

characterized in that the q coding modes of the subset are regularly adapted to the content of the pixel blocks of the sequence.

The first criterion is for example a bitrate-distortion optimization or bitrate optimization or distortion optimization criterion well known to those skilled in the art.

Thus, the coder always only has a reduced number q<n of coding modes available, called available coding modes, to code the current pixel block but this subset of q coding modes is regularly modified according to the pixel blocks already coded.

According to a preferred embodiment, the method further comprises the following steps:

determining the probability of occurrence of each coding mode of the subset of q coding modes during the coding operation,

regularly determining the coding mode or modes of the subset having a probability of occurrence less than a first threshold,

selecting, from among the modes of the set of n coding modes, modes, known as replacement modes, not belonging to the subset of q coding modes,

replacing, in the subset of q coding modes, each of the coding modes having a probability of occurrence less than the first threshold by a replacement mode.

The probability of occurrence of a coding mode corresponds for example to the rate of occurrence of this coding mode in the already coded blocks of the image or of the sequence.

Thus, according to the invention, at the coder and at the decoder, a reduced number q of coding modes are used from among the n possible coding modes and the content of this subset of q coding modes is periodically adapted to the content of the image to be coded or decoded.

To do this, the underused coding modes of the subset of q coding modes are determined and replaced by other coding modes from among the remaining n-q coding modes.

According to a particular embodiment, the coding mode or modes having a probability of occurrence less than the first threshold are determined at the start of each sequence or image or slice. The subset of q coding modes is thus updated at the start of each sequence or image or slice.

The first threshold is advantageously predetermined and for example

$$\frac{1}{10 \cdot q} .$$

equal to

Advantageously, the replacement is only performed if the number of pixel blocks coded since the last replacement is greater than a second threshold, for example 64, to prevent replacements which are too frequent.

According to a particular embodiment, the number q is fixed. In a variant, the number q varies according to the image or the sequence to be coded.

According to a particular embodiment, the selection of the replacement modes comprises the following steps:

classifying the n coding modes according to their degree of relevance according to a second predetermined criterion, and

selecting, for each coding mode having a probability of occurrence less than the first threshold, a replacement mode from among the most relevant coding modes according to said second predetermined criterion not already belonging to the subset of q coding modes.

According to another, simpler embodiment, the replacement modes are selected from among the n-q coding modes not present in the subset of q coding modes according to a third predetermined criterion, for example by selecting the coding modes having the highest probabilities of occurrence (probabilities calculated previously when these modes belonged to the subset of q coding modes).

According to a particular embodiment, the coded blocks being inserted into a bitstream, an item of information identifying the q coding modes of the subset is also inserted into said bitstream after each step of replacement of coding modes, or at the start of each sequence or image or slice. Said item of information arises for example in the form of an equivalence table which is updated at the start of each sequence or image or slice. Advantageously, an item of information indicating the number q used is also inserted into the bitstream at the start of each sequence or image or slice.

According to a particular embodiment, said first and second predetermined criteria are identical and are bitrate-distortion optimization criteria. In a variant, two different criteria are used, for example a bitrate-distortion optimization criterion for the first criterion and a bitrate or distortion optimization criterion for the second criterion or vice versa.

The invention also relates to a method for decoding coded pixel blocks of a video sequence comprising a step of decoding of each of the pixel blocks according to a coding mode selected, according to a predetermined criterion, from a subset of q coding modes of a set of n possible coding modes, where q<n,

characterized in that the q coding modes of the subset are regularly adapted to the content of the pixel blocks of the sequence.

This method advantageously comprises the following steps:

determining the probability of occurrence of each coding mode of the subset of q coding modes during the decoding operation,

regularly determining the coding mode or modes of the subset having a probability of occurrence less than a threshold,

receiving an item of update information identifying, from among the n coding modes, modes, known as replacement modes, not belonging to the subset of q coding modes, and

replacing, in the subset of q coding modes, each of the coding modes having a probability of occurrence less than the threshold by a replacement mode.

Said item of update information is provided in the bitstream of the sequence to be decoded.

### BRIEF DESCRIPTION OF THE FIGURES

Other advantages may also occur to those skilled in the art upon reading the examples below, illustrated by the annexed figures, given by way of illustration.

FIG. 1 shows a flow chart of the steps of the coding method according to the invention;

FIG. 2 shows a flow chart of the steps of the decoding method according to the invention;

FIG. 3 shows a coding device according to the invention; and

FIG. 4 shows a decoding device according to the invention.

### DETAILED DESCRIPTION OF AT LEAST ONE EMBODIMENT

According to the invention, it is considered that the coder and the decoder have a set of M={m₁, . . . , mₙ) of n possible coding modes for coding pixel blocks.

By way of example, these modes are different intra coding (spatial prediction) modes or different inter coding (temporal prediction) modes, as defined in the MPEG-4 standard. However, the invention is not limited to this standard. Generally, a large number of coding modes are possible, it being possible for distinct modes to correspond to a same prediction algorithm configured with different parameters. It is possible for example to have several coding modes based on an intra prediction using a displaced DCT transformation, as defined in the document “Sparse shift-DCT spatial prediction” by D. Thoreau, A. Martin, E. Frangois, J. Vieron and Q. Huynh-Thu, Proceedings of 2010 IEEE 17th ICIP, 26-29 Sep. 2010, Hong Kong, the different modes corresponding for example to different threshold values or different DCT transformation sizes.

According to the invention, the number of available coding modes is limited to a subset M′ of the set M of n coding modes. This subset comprises q coding modes where q<n. The purpose of this reduction in the number of available coding modes is to reduce the signaling cost of the coding modes used, that is to say to reduce the number of bits required for coding the coding mode indices as will be shown later. This means that, at a given moment, only q coding modes from among the n possible coding modes can be used for prediction.

The number q of available coding modes can be fixed once and for all regardless of the sequence to be coded or it can be varied at the start of each sequence, image or slice. In this case, it is coded into the bitstream of the sequence at the start of the sequence, image or slice. For example, n=16 and q=8.

The coder, like the decoder, thus manages an equivalence table associating with each coding mode of the subset M′ a coding mode from among the n coding modes of the set M.

The equivalence table is presented for example in the following form:

| Index of q modes of the | Index of the coding |
|---|---|
| subset M′ | modes of the set M |
| 1 | e₁ |
| 2 | e₂ |
| . . . | . . . |
| i | eᵢ |
| . . . | . . . |
| q | eᵢ |

In this table, i designates the index of the modes of the subset M′ and is comprised in the interval [1 . . . q]. eᵢ, designates the index of the modes of the set M and is comprised in the interval [1 . . . n].

This table therefore associates in a one-to-one manner a coding mode, denoted mₑᵢ, of the set of n coding modes, where eᵢ, ∈ [1 . . . n], with each coding mode, denoted m′ᵢ, of the subset of q coding modes, where i ∈ [1 . . . q].

At the start of the process, this equivalence table is filled with default values in the coder and the decoder or the coder transmits it in the bitstream at the start of the sequence, image or slice. At the start of the process, we take for example eᵢ=i.

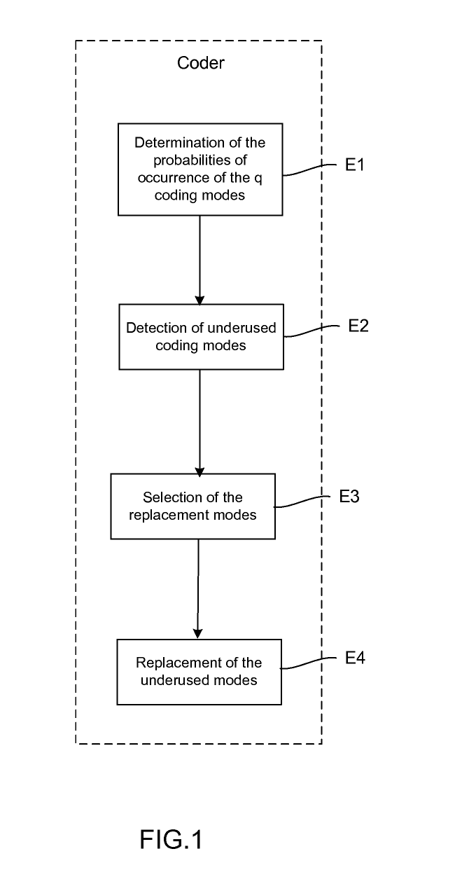

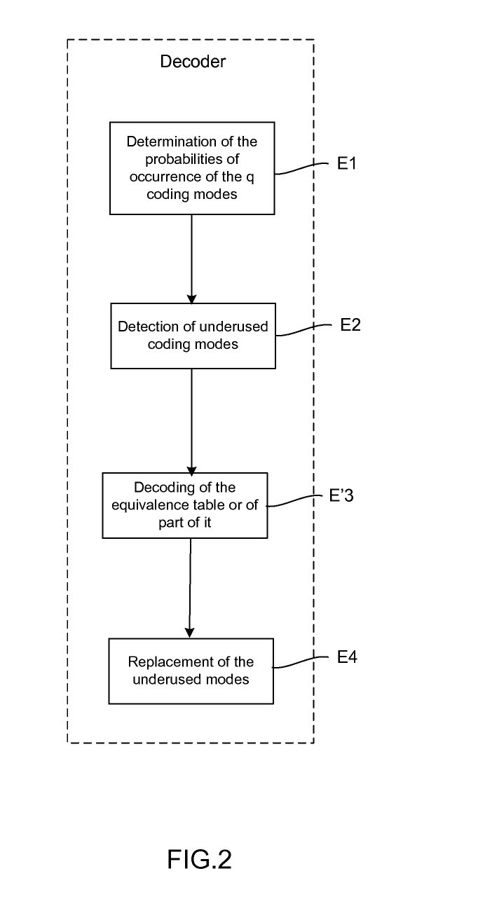

According to the invention, this equivalence table is regularly updated according to the rate of use of the q coding modes selected for the coding. FIG. 1 shows the steps of the coding method according to the invention. FIG. 2 shows the steps of the decoding method according to the invention. The steps of the decoding method identical to the steps of the coding method are identified in FIG. 2 using the same references.

According to a first step E1, after coding or decoding each pixel block, the probability of occurrence of each coding mode of the subset M′ is determined. The coder and the decoder continuously calculate the probabilities pᵢ, of the coding modes m′ᵢ=mₑᵢ, of the subset M′, where i=1, . . . , q, after coding/decoding pixel blocks. A typical algorithm for updating the probabilities pᵢ consists for example of the following formula:

∀i ∈ [1 . . . q], pᵢ=a·pᵢ+d(k,i)·b

followed by a normalization

$${p}_{i} = \frac{{p}_{i}}{{\sum }_{j = 1}^{q} {p}_{j}}$$

where:

a and b represent two predefined parameters, predefined either by default or transmitted in the bitstream at the start of the sequence or image or slice, such that a +b=1,

k represents the index of the coding mode of the coded or decoded pixel block,

d( )is a function such that d(x,y)=1 if x=y, 0 otherwise.

The probabilities pᵢ are initially fixed at predefined values, either defined by default or transmitted in the bitstream at the start of the sequence or image or slice. These initial probabilities have the effect of preventing a coding mode newly introduced into the subset starting off at a disadvantage (zero probability of occurrence) with respect to the coding modes of the subset.

This step E1 is carried out both in the coder and the decoder.

According to a second step E2, the coding modes of the subset M′ having a probability of occurrence less than a threshold, that is to say the underused coding modes, are regularly determined.

This step consists in detecting the coding modes whose probability of occurrence is less than a threshold λₚ. This threshold is either in the bistream at the start of the sequence or image or slice or is fixed by the coder and the decoder.

The detection of the underused coding modes consists in searching for the coding modes of index i having a probability of occurrence pi less than λₚ.

A typical value of λhd p is for example 1/(10*q). In this case, it is considered that, when a coding mode is 10 times less used than the usage average of the coding modes, this mode is underused.

To prevent detections being too frequent, this operation is not carried out after coding or decoding each pixel block but is, for example, carried out at the start of each sequence or image or slice.

A threshold Nₘᵢₙ can also be added, representing the minimum number of pixel blocks to be coded or decoded between two successive detections. Coding mode i will only be considered as underused if its probability of occurrence pᵢ is less than λₚ and if the number of pixel blocks coded or decoded since the last detection is greater than Nₘᵢₙ. This parameter fixes a minimum period between two coding mode changes. It enables prevention of a certain instability which would be due to a mode permutation which is too frequent. Nₘᵢₙ is for example equal to 64.

This step E2 is carried out in the coder and the decoder.

The following step E3 consists in selecting coding modes intended to replace the underused coding modes.

To do this, according to a first embodiment, the n coding modes are classified according to their degree of relevance according to a predetermined criterion, for example a bitrate distortion optimization criterion. The n coding modes are classified from the most relevant to the least relevant in terms of the bitrate distortion optimization criterion. Then, from among the modes not already belonging to the subset M′, the most relevant modes in terms of the bitrate distortion optimization criterion are selected as replacement modes.

In this particular embodiment, the coder tests all possible coding modes for each block to be coded, that is to say the n coding modes of the set M, even if the selection of the coding mode for coding the current block is performed in the subset M′. This makes it possible to have a large choice of replacement modes and to have the most relevant replacement modes of the set M in terms of the bitrate-distortion criterion but this also increase the complexity of the encoding.

This is why, according to another embodiment, the replacement modes are chosen from among the n-q coding modes not present in the subset of q coding modes according to a predefined criterion, for example by selecting the coding modes having the highest probabilities of occurrence (probabilities calculated previously when these modes belonged to the subset of q coding modes) or possibly by selecting modes from among the n-q unused coding modes according to their initial probabilities which can be different. According to another embodiment, the replacement modes are randomly selected from among the n-q unused coding modes.

The equivalence table is updated by the coder, the selected replacement modes replacing the underused coding modes. This step E3 is only carried out by the coder. The equivalence table is then coded into the bitstream for transmission to the decoder which receives it and decodes it during a step E′3.

In the following step, E4, the coder or decoder replaces, in the subset M′, each of the underused coding modes by a replacement mode.

The probabilities of occurrence of the coding modes of the new subset M′ are updated again. Initial probability values are assigned to the new coding modes of the subset M′. The probabilities of the other coding modes of the subset M′ are rescaled for example by the following formula

$${p}_{i} = \frac{{p}_{i}}{{\sum }_{j ∈ Q} {p}_{j}} - \frac{{\sum }_{k ∈ K} {p}_{k}}{q}$$

Where

Q is the set of indices of the coding modes of the subset M′ which are not underused (i.e. which have not been replaced), and

K is the set of indices of the new coding modes (replacement modes) of the subset M′, and

pₖ are the initial probabilities of the new coding modes of the subset M′.

The sum of the probabilities of occurrence of the coding modes of the subset M′ is thus equal to 1.

As indicated previously, the initial probabilities of occurrence are equal to default values in the coder and the decoder or they are values fixed by the coder then transmitted in the bitstream to the decoder.

In a simplified version, only the part of the equivalence table relating to the underused coding modes and to their replacement mode is transmitted to the decoder.

In order to perform step E4, the decoder receives and decodes during a step E′3 the equivalence table or the part of this relating to the underused coding modes and to their replacement mode. It receives if necessary the initial probabilities of the replacement modes. It replaces in this case, in the subset M′, the underused modes by the replacement modes defined in the equivalence table.

The coding and decoding method of the invention will be illustrated hereafter by an example.

For example, a coder or a decoder having n=16 possible coding modes is considered. Only q=8 coding modes are available at each moment for coding or decoding the future pixel blocks. We have for example

M={m₁,m₂,m₃,m₄,m₅, m₆,m₇,m₈,m₉,m₁₀,m₁₁,m₁₂,m₁₃,m₁₄,m₁₅,m₁₆}

M′={m′₁,m′₂,m′₃,m′₄,m′₅,m′₆,m′₇,m′₈}

where m′₁=rn₁
m′₂=m₃
m′₃=m₄
m′₄=m₅
m′₅=m₈
m′₆=m₁₁
m′₇=m₁₂
m′₈=m₁₃

The coder or decoder determines a probability of occurrence for each of the coding modes m′ᵢ, where i ∈ [1 . . . 8]. It then determines, at the start of each image or slice, the coding modes of M′ having a probability of occurrence less than the thresholds λₚ. It is possibly verified that the number of pixel blocks coded or decoded since the last detection of underused modes is greater than Nₘᵢₙ. The modes m′₃=m₄ and m′₄=m₅ are for example detected as underused.

The coder then selects the replacement modes from among the modes {m₂,m₆,m₇,m₉,m₁₀,m₁₄,m₁₅,m₁₆} not contained in the subset M′. The coder examines for example, the probabilities of occurrence (probabilities of occurrence calculated when they were previously in the subset M′ or initial probabilities) of these modes and selects for example the replacement modes m₂ and m₉ to replace the modes m₄ and m₅ in the subset M′. We therefore have, in the new subset M′, m′₃=m₂ and m′₄=m₉. The new subset M′ comprises the following coding modes: m′₁₌ₘ₁, m′₂=m₃, m′₃=m₂, m′₄=m₉, m′₅=m₈, m′₆=m₁₁, m′₇=m₁₂ and m′₈=m₁₃.

The coder then updates the equivalence table with the replacement modes, codes it and transmits it to the decoder.

The coder and the decoder thus replace in the subset M′ the underused coding modes by the replacement modes defined in the equivalence table.

The future pixel blocks are coded or decoded with this new subset M′ of coding modes. More specifically, on the coder side, a coding mode is selected for the current block in the subset M′. A prediction block is determined from the selected mode. A residual block is determined from the current block and the prediction block. The residual block is then transformed then quantized. The quantized residual block is then coded by entropy coding. An index of the mode chosen for predicting the current block is also coded into the stream.

On the decoder side, the index of the mode chosen for predicting the current block is decoded from the stream. This index makes it possible to determine in the subset M′ the mode to be used for the prediction of the current block. Likewise, a residual block is decoded for the current block. The decoded residual block undergoes an inverse quantization then an inverse transformation. A prediction block is determines from the mode identified by the mode index. The current bock is determined from the decoded residual block and the prediction block.

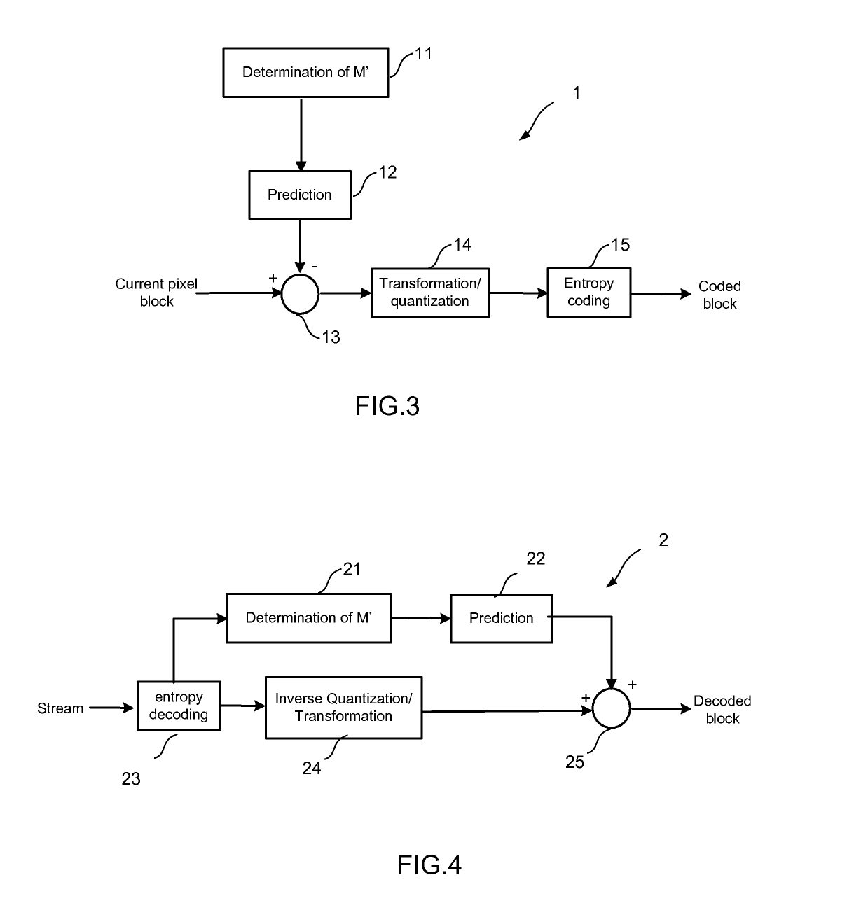

The process for determining the q modes of the subset M′ is for example implemented in a coder as shown by FIG. 3. This coder, referenced 1, comprises a module 11 for determining the q modes of the subset M′. Module 11 is able to implement steps E1 to E4 of the coding method. The coder 1 also comprises a module 12 for determining a prediction block from a prediction mode selected from the subset M′, e.g. according to a criterion of bitrate-distortion type, a differential module 13 for generating a residual block from the prediction block and the current block, a transformation and quantization module 14 for generating a quantized residual block and an entropy coding module 15 for coding the quantized residual block and the index of the chosen prediction mode for coding this block into the data stream to be transmitted.

The process for determining the q modes of the subset M′ is for example implemented in a decoder 2 as shown by FIG. 4. This decoder comprises a module 21 for determining the q modes of the subset M′. Module 21 is able to implement steps E1, E2, E′3 and E4 of the decoding method. The decoder 2 comprises a prediction module 22 able to determine for the current block a prediction block from a prediction mode index, an entropy decoding module 23 able to generate a residual block corresponding to the current block to be decoded and the prediction mode index for the current block, a module 24 for inverse quantization and inverse transformation of the decoded residual block and a module 25 for adding the pixel blocks from the prediction module 22 and from module 24 to generate the decoded current block. The prediction mode index makes it possible to determine the prediction mode in the subset M′.

The coder 1 and the decoder 2 according to the invention are for example implemented on a computer platform having hardware components such as one or more microprocessors or CPUs, a random access memory (RAM), a non-volatile memory of ROM (Read Only Memory) type and one or more input/output interface(s) which are connected to each other by an address and data bus. The platform can also comprise a man-machine interface. The platform generally comprises an operating and microcoding system. According to an implementation example, the algorithms implementing the steps of the methods specific to the invention are stored in the ROM memory. When powered up, the microprocessor loads and runs the instructions of these algorithms.

According to variants, coders and decoders compatible with the invention are implemented according to a purely hardware realization, for example in the form of a dedicated component (for example in an ASIC (Application Specific Integrated Circuit) or FPGA (Field-Programmable Gate Array) or VLSI (Very Large Scale Integration) or of several electronic components integrated into a device or even in a form of a mix of hardware elements and software elements.

Although the invention has been described in relation to different particular embodiments, it is obvious that it is in no way restricted and that it comprises all the technical equivalents of the means described together with their combinations if the latter fall within the scope of the invention.

In the present description, a bitrate-distortion optimization criterion is used to select the prediction block to be used for a current block. Naturally, other criteria can be used, for example bitrate optimization criteria or distortion optimization criteria.

Although the invention has been described in relation to different particular embodiments, it is obvious that it is in no way restricted and that it comprises all the technical equivalents of the means described together with their combinations if the latter fall within the scope of the invention.

1-17. (canceled)

18. Method for coding pixel blocks of a video sequence comprising coding each of the pixel blocks according to a coding mode selected in a subset of q coding modes of a set of n possible coding modes, where q<n, wherein coding comprises replacing, in the subset of q coding modes, each of the coding modes having a probability of occurrence during coding less than a first threshold by a replacement mode, said replacement mode being one of the n modes not comprised in the q modes.

19. Method according to claim 18, wherein replacing, in the subset of q coding modes, each of the coding modes having a probability of occurrence less than a first threshold by a replacement mode comprises:
determining the probability of occurrence of each coding mode of the subset of q coding modes during coding,
determining the coding mode or modes of the subset having a probability of occurrence less than a first threshold,
selecting replacement modes from among the modes of the set of n coding modes not belonging to the subset of q coding modes, and
replacing, in the subset of q coding modes, each of the coding modes having a probability of occurrence less than the first threshold by a replacement mode.

20. Method according to claim 19, wherein the coding mode or modes having a probability of occurrence less than the first threshold are determined at the start of each sequence or image or slice.

21. Method according to claim 19, wherein the first threshold is equal to
$$\frac{1}{10 \cdot q} .$$

22. Method according to claim 19, wherein the replacement is performed if the number of pixel blocks coded since the last replacement is greater than a second threshold.

23. Method according to claim 19, wherein selecting the replacement modes comprises:
classifying the n coding modes according to their degree of relevance according to a second predetermined criterion, and
selecting, for each coding mode of the subset having a probability of occurrence less than the first threshold, a replacement mode not already belonging to the subset of q coding modes from among the most relevant coding modes according to said second predetermined criterion.

24. Method according to claim 19, wherein the replacement modes are selected from among the n-q coding modes not present in the subset of q coding modes according to probabilities of occurrence previously determined for said n-q coding modes not present in the subset of q coding modes.

25. Method according to claim 19, wherein, the blocks being coded into a bitstream, an item of information identifying the q coding modes of the subset is also coded into said bitstream after each step of replacement of coding modes, or at the start of each sequence or image or slice.

26. Method according to claim 18, wherein the number q is fixed.

27. Method according to claim 18, wherein the number q varies according to the image or the sequence to be coded.

28. Method for decoding coded pixel blocks of a video sequence comprising decoding each of the pixel blocks according to a coding mode selected from a subset of q coding modes of a set of n possible coding modes, where q<n, wherein decoding comprises replacing, in the subset of q coding modes, each of the coding modes having a probability of occurrence during decoding less than a first threshold by a replacement mode, said replacement mode being one of the n modes not comprised in the q modes.

29. Method according to claim 28, wherein replacing, in the subset of q coding modes, each of the coding modes having a probability of occurrence during decoding less than a first threshold by a replacement mode comprises:
determining the probability of occurrence of each coding mode of the subset of q coding modes during decoding,
determining the coding mode or modes of the subset having a probability of occurrence less than a threshold,
receiving an item of update information identifying replacement modes from among the n coding modes, not belonging to the subset of q coding modes, and
replacing, in the subset of q coding modes, each of the coding modes having a probability of occurrence less than the threshold by a replacement mode.

30. Method according to claim 29, wherein said item of update information is decoded.

31. Encoder for coding pixel blocks of a video sequence comprising at least a processor configured to code each of the pixel blocks according to a coding mode selected in a subset of q coding modes of a set of n possible coding modes, where q<n,
wherein the at least a processor if further configured to replace, in the subset of q coding modes, each of the coding modes having a probability of occurrence during coding less than a first threshold by a replacement mode, said replacement mode being one of the n modes not comprised in the q modes.

32. Decoder for decoding pixel blocks of a video sequence comprising at least a processor configured to decode each of the pixel blocks according to a coding mode selected in a subset of q coding modes of a set of n possible coding modes, where q<n,
wherein the at least a processor if further configured to replace, in the subset of q coding modes, each of the coding modes having a probability of occurrence during decoding less than a first threshold by a replacement mode, said replacement mode being one of the n modes not comprised in the q modes.

33. Encoder according to claim 31, wherein to replace, in the subset of q coding modes, each of the coding modes having a probability of occurrence less than a first threshold by a replacement mode comprises:
determining the probability of occurrence of each coding mode of the subset of q coding modes during coding,
determining the coding mode or modes of the subset having a probability of occurrence less than a first threshold,
selecting replacement modes from among the modes of the set of n coding modes not belonging to the subset of q coding modes, and
replacing, in the subset of q coding modes, each of the coding modes having a probability of occurrence less than the first threshold by a replacement mode.

34. Encoder according to claim 33, wherein the coding mode or modes having a probability of occurrence less than the first threshold are determined at the start of each sequence or image or slice.

35. Encoder according to claim 33, wherein the first threshold is equal to
$$\frac{1}{10 \cdot q} .$$

36. Encoder according to claim 33, wherein the replacement is performed if the number of pixel blocks coded since the last replacement is greater than a second threshold.

37. Encoder according to claim 33, wherein the selection of the replacement modes comprises:
classifying the n coding modes according to their degree of relevance according to a second predetermined criterion, and
selecting, for each coding mode of the subset having a probability of occurrence less than the first threshold, a replacement mode not already belonging to the subset of q coding modes from among the most relevant coding modes according to said second predetermined criterion.

38. Encoder according to claim 33, wherein the replacement modes are selected from among the n-q coding modes not present in the subset of q coding modes according to probabilities of occurrence previously determined for said n-q coding modes not present in the subset of q coding modes.

39. Encoder according to claim 33, wherein, the blocks being coded into a bitstream, an item of information identifying the q coding modes of the subset is also coded into said bitstream after each step of replacement of coding modes, or at the start of each sequence or image or slice.

40. Encoder according to claim 31, wherein the number q is fixed.

41. Encoder according to claim 31, wherein the number q varies according to the image or the sequence to be coded.

42. Decoder according to claim 28, wherein to replace, in the subset of q coding modes, each of the coding modes having a probability of occurrence during decoding less than a first threshold by a replacement mode comprises:
determining the probability of occurrence of each coding mode of the subset of q coding modes during decoding,
determining the coding mode or modes of the subset having a probability of occurrence less than a threshold,
receiving an item of update information identifying replacement modes from among the n coding modes, not belonging to the subset of q coding modes, and
replacing, in the subset of q coding modes, each of the coding modes having a probability of occurrence less than the threshold by a replacement mode.

43. Decoder according to claim 42, wherein said item of update information is decoded.
